(19) United States
(12) Patent Application Publication
(10) Pub. No.: US 2015/0286787 A1
(43) Pub. Date: Oct. 8, 2015

(54) SYSTEM AND METHOD FOR MANAGING HEALTHCARE

(71) Applicant: Seamless Mobile Health Inc., TORONTO (CA)

(72) Inventors: PHILIP YUAN CHEN, TORONTO (CA); JOSHUA PAUL LlU, TORONTO (CA); WILLIE KA CHING KWOK, VANCOUVER (CA)

(21) Appl. No.: 14/679,663

(22) Filed: Apr. 6, 2015

Related U.S. Application Data
(60) Provisional application No. 61/975,484, filed on Apr. 4, 2014.

(51) Int. Cl. G06F 19/00; G06Q 50/22

(52) U.S. Cl. CPC G06F 19/3418; G06Q 50/22

(57) ABSTRACT

Systems for automated transmission of communications to a patient following clinical treatment comprising: electronic datastores storing: a clinical profile reflective of characteristics of (i) the patient; and (ii) clinical treatment undergone by the patient; a response profile reflective of characteristics of responses by the patient to past communications; and a communication modality profile reflective of characteristics of communication channels or devices available for transmission of communications; communication interfaces associated with respective communication channels or devices; processors in communication with electronic datastores, the processors configured for: generating a communication to the patient based on the clinical profile, the communication providing a recommendation or inquiry to the patient; selecting communication channels or devices based on at least one of (i) the clinical profile and (ii) the response profile; and transmitting the generated communication to the patient by way of the communication interface associated with the selected communication channel or device.

### CROSS-REFERENCE TO RELATED APPLICATION

This application claims the benefit of U.S. Provisional Application No. 61/975,484, filed Apr. 4, 2014.

### FIELD

This disclosure relates generally to healthcare management systems, and more particularly to systems and methods for managing healthcare.

### BACKGROUND

Following clinical treatment, a patient may periodically engage healthcare practitioners or healthcare resources in an effort to monitor the patient's recovery, to identify any complications that arise and to obtain further treatment, if necessary.

The monitoring of recovery may be a factor in improving the healthcare outcomes for the patient, as issues requiring attention and/or further treatment by practitioners can be identified.

Post-operative care of a patient may be a resource intensive process, in particular, where a healthcare provider is providing healthcare to a number of patients, each of whom may have different characteristics and have undertaken different medical treatments.

### SUMMARY OF THE INVENTION

A system for automated transmission of communications to a patient following clinical treatment, the system comprising: one or more electronic datastores storing: a clinical profile reflective of characteristics of (i) the patient; and (ii) clinical treatment undergone by the patient; a response profile reflective of characteristics of responses by the patient to past communications transmitted by the system; and a communication modality profile reflective of characteristics of one or more communication channels or devices available for transmission of communications to the patient; one or more communication interfaces associated with a respective one of the communication channels or devices; one or more processors in communication with the one or more electronic datastores, the one or more processors configured for: generating a communication to the patient based on the clinical profile, the communication providing a recommendation or inquiry to the patient; selecting one of communication channels or devices based on at least one of (i) the clinical profile and (ii) the response profile; and transmitting the generated communication to the patient by way of the communication interface associated with the selected communication channel or device.

In another aspect, the one or more electronic datastores further store a plurality of predefined communications and a plurality of predefined rules governing when the communications should be presented to the patient.

In another aspect, said generating comprises applying the predefined rules to select from amongst the predefined communications based on the clinical profile.

In another aspect, the one or more processors are further configured for: forming a data structure comprising at least part of the plurality of predefined communications and at least part of the plurality of predefined rules; and transmitting the data structure by way of communication interface associated with the selected communication channel or device, for later generation and presentation of communications to the patient.

In another aspect, the system is further configured for scheduling a time for presenting the communication to the patient.

In another aspect, said scheduling is based on the clinical profile of the patient.

In another aspect, the one or more electronic datastores further stores aggregated response characteristics for responses to past communications by a population of patients.

In another aspect, said scheduling is based on the aggregate response characteristics.

In another aspect, said transmitting comprises transmitting the generated communication at the scheduled time.

In another aspect, the transmitting comprises transmitting the generated communication with an indicator of the scheduled time, for later presentation to the patient at the scheduled time.

In another aspect, the one or more communication interfaces comprises at least one of (i) a WiFi interface, (ii) a mobile telephony interface (iii) a cellular network interface, (iv) a short message system interface, (v) an electronic mail interface, (vi) a web application interface and (vii) a mobile notification interface.

A computer-implemented method for automated transmission of communications to a patient following clinical treatment, the method comprising: maintaining in one or more electronic datastores: a clinical profile reflective of characteristics of (i) the patient; and (ii) clinical treatment undergone by the patient; a response profile reflective of characteristics of responses by the patient to past communications transmitted by the system; and a communication modality profile reflective of characteristics of one or more communication channels or devices available for transmission of communications to the patient; at one or more processors one or more processors in communication with the one or more electronic datastores: generating a communication to the patient based on the clinical profile, the communication providing a recommendation or inquiry to the patient; selecting one of communication channels or devices based on at least one of (i) the clinical profile and (ii) the response profile; and transmitting the generated communication to the patient by way of a communication interface associated with the selected communication channel or device.

The system may be implemented using various means and various technologies. In some embodiments of the invention, the system may be implemented using one or more servers, one or more processors, one or more non-transitory computer-readable media, one or more interfaces, etc. In alternate embodiments of the invention, the system may be implemented using distributed computing and network technologies, such as cloud computing implementations.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 is an illustrative diagram providing a generic computer hardware and software implementation of certain aspects, as detailed in the description.

FIG. 2 is a system diagram illustrating the components of the healthcare management platform and system, in one representative implementation in accordance with some embodiments.

FIG. 3 is sample diagram illustrating the relationships between inputs, such as patient data and question answers, and recommendations, according to some embodiments.

FIG. 4 illustrates a sample heatmap indicating the responses received from a patient with respect to a procedure, and is color coded based upon a set of rules, according to some embodiments.

FIG. 5 illustrates a sample analytics dashboard with various filtering applied, according to some embodiments.

FIG. 6 illustrates a sample analytics dashboard with various filtering applied, according to some embodiments.

FIG. 7 illustrates a sample analytics dashboard with various filtering applied, according to some embodiments.

FIG. 8 provides a sample screenshot of a screen used to add a procedure for a particular patient, according to some embodiments.

FIG. 9A illustrates an input screen where a patient is asked for and may provide his/her temperature, according to some embodiments.

FIG. 9B illustrates an input screen where a patient is asked a discrete question with radio buttons for selecting a response, according to some embodiments.

FIG. 9C illustrates an input screen where a patient is able to interactively indicate the level of pain at an incision site, according to some embodiments.

FIG. 10A illustrates an input screen where a patient may indicate what symptoms the patient is feeling for a particular day, according to some embodiments.

FIG. 10B illustrates an input screen where a patient can indicate where the patient is feeling pain, according to some embodiments.

FIG. 10C illustrates an input screen where a patient is requested and may upload a photograph of their surgical wound, according to some embodiments.

FIG. 11 illustrates a sample recommendation screen that may be provided upon completion of all the questions for a given day, according to some embodiments.

FIG. 12A illustrates a sample recommendation screen recommending a patient undergo some exercises, according to some embodiments.

FIG. 12B illustrates a sample education screen that provides a pictorial indication of the types of exercises that one may conduct, according to some embodiments.

FIG. 13 is a screenshot of a page where a patient is able to indicate on the patient's profile various preferences in relation to methods of communication, according to some embodiments.

FIG. 14A is a sample depiction of questions posed on a text only program, according to some embodiments.

FIG. 14B is a sample depiction of questions posed on an application on a tablet, according to some embodiments.

FIG. 14C is a sample depiction of questions posed on a smart watch, according to some embodiments.

### DETAILED DESCRIPTION

Providing healthcare to a number of individuals following various treatments may be resource intensive, especially where a healthcare organization is providing healthcare to a number of patients. Scalability may be a consideration as there may be limited resources (e.g., physician time, equipment, nurses). There may be a desire to tailor and/or customize services based on the specific needs of a particular patient, or characteristics that can be determined and/or interpolated based on the patient's profile.

There may be some advantage in leveraging mobile technologies (cellular connectivity, smart phones/tablets, wearable electronics, etc.) in delivering services in the field of healthcare applications. Patients may already own some of these devices, or may be provided devices for communicating with healthcare practitioners or tracking their own recovery.

In some embodiments, it may be desirable to provide systems and methods that are able to provide services while a user is not connected to a network, or is intermittently connected to a network.

In some embodiments, a system may be provided to facilitate the monitoring of the healthcare of one or more patients. The system may also be configured to facilitate the development of instructional and educational materials based on inputs, such as expert questionnaires, reports, etc.

For example, a platform may be provided that allows healthcare providers to: (a) generate interactive clinical content and feedback rule sets; (b) collect and monitor patient-generated health data; (c) provide automated, personalized clinical recommendations and patient education; and/or (d) conduct remote patient tracking/analysis at both individual and population levels.

In some embodiments, the system is further comprised of a module to generate containers which contain information relevant to the treatment of particular conditions or the post-operative care after particular treatments, which may include, but are not limited to, questionnaires, educational materials, recommendations, healthcare logic flows, timed notifications, etc. These containers may be transmitted to a patient's terminal or mobile device upon the provisioning of their account or adding a procedure to a patient's profile; the transmitted container provides the patient with functionality regardless of whether the patient is connected to the network after the container has been transmitted.

For example, after a surgical procedure, a patient creates an account on the system and a container is transmitted to his/her mobile device. The patient may be able to keep track of his/her progress and receive timely notifications even if the patient is not connected to the Internet. When the patient reconnects to the Internet, the mobile application may update the system with healthcare relevant data generated while the patient was not connected to the Internet. An illustrative, non-limiting example of use is provided, the example is merely provided to help the reader understand some aspects; various embodiments may have more or less steps or functionality and this example should not be understood as definitive.

In an example, a patient is discharged from hospital after a hip surgery. The patient may be provided a username/password to login to the system by their healthcare provider, and is asked to use the system during their recovery. The patient may then download an application from the application store/digital distribution (e.g., app store, Google play store) or access a web interface.

The system receives, from various sources (e.g., electronic health records), specific patient variables that are provided (e.g., surgery type, age, sex, surgeon, etc.) and may generate a tailored set of content based upon these patient variables.

Periodically, (e.g., each day) the patient answers various questions that has been designed relating to, for example, hip surgery and has been tailored to his other patient variables (e.g., Is your wound red? Have you eaten in the last 24 hours? What is your temperature?). The patient may be reminded to complete the questionnaire by notifications (SMS, IVR, email, in-app notifications). These notifications may arrive through various communication modalities, and the system may be configured with various rules that switch between various notification types, frequencies and/or modalities depending on various conditions experienced by the system (e.g., a patient has not responded to the last 5 emails, so a call is made).

After the patient records their signs/symptoms, the patient may be provided a personalized, automated recommendation (e.g., the recommendation may be provided through a set of rules, and the recommendations may also be tailored and/or refined over time using population-level trends and/or study results).

A normally recovering patient may, for example, be provided a recommendation of “no identifiable concerns” with no specific actions. If the patient has mild concerns, such as mild wound care concerns, a patient education module may generate some educational materials to help them self-manage their wound (e.g., please remember to change your bandage today). However, a patient with more serious concerns, such as a fever (e.g., a sign of a potential infection), may be prompted to seek the appropriate medical help (e.g., call the hospital nurse or go to the emergency department). These recommendations may be tied to an automated analysis of healthcare outcomes associated with each of the factors as determined by the system, for example, determined through statistical relationships such as correlations, cross-correlations, etc.

At the hospital, the surgeon or nurse may be able to monitor the patient-generated data through an interface (e.g., a secure web portal). The healthcare provider can also receive notifications (e.g., SMS, IVR, email) if a patient's situation is deteriorating, based on various rules (e.g., the patient-generated data being outside what is considered a normal range of values). This may allow the healthcare provider to be proactive and intervene before problems get worse. This may also allow the healthcare provider to make better remote assessments, such as the ability to see changes in the wound photo data and respond appropriately (e.g., the wound appears to be infected).

The healthcare provider may also be provided an analytics dashboard that facilitates the analysis of patient generated health data (e.g., filtering, comparisons, trend analysis). For example, comparisons may be made through facility-specific categories (e.g., surgeon, surgical procedure, surgery department, hospital, geographical region), patient variables (e.g., sex, age, surgical procedure) and time (e.g., specific to the recovery phase, over time periods).

Patients may include individuals who have undergone a medical procedure and are utilizing the system to manage their healthcare outside of a hospital environment. The term patients is broadly used; it is contemplated that for some patients, another individual may utilize the program in helping a patient log/monitor his/her treatment. For example, a person who may have burned hands may ask his/her spouse to use the application in monitoring his/her treatment following an operation.

Clinician is a broad term used to describe any individual involved in the healthcare process, and may include individuals such as nurses, doctors, hospital administrators, care experts, etc.

In some embodiments, systems and methods are provided to facilitate the patient-healthcare provider interaction. For example, some embodiments are configured to provide higher efficiency and scalability through automation and/or the application of logical rules.

The following sections provide details, at a high level, of some aspects of the some embodiments.

### Procedures

In the context of this specification, a procedure may be defined as a set of elements that may be comprised of: a questionnaire, rules, recommendations, educational content and additional elements related to a specific medical condition (e.g., diabetes, heart failure, etc.) or surgical procedure (e.g., hip surgery). One or more procedures may be assigned to patients depending on the particular circumstances of each patient (e.g., John Hancock had undergone surgery to remove a kidney stone, and also has diabetes). Every patient user is assigned at least one procedure.

The set of elements comprising a procedure may be tailored depending on the particular needs of a patient or tailored by clinicians to provide a specific course of treatment. The set of elements may further be developed, in whole or in part, by one or more third party experts.

### Questions/Questionnaires

In the context of this specification, a questionnaire may be comprised of a series of questions to be completed by the patient user, comprising of one or more discrete questions.

Each question may be designed to ask the user to record specific clinical signs/symptoms, such as temperature, pain, etc., from a range of structured, input options. Question input types may include, but are not exclusive to, touch-based selection (checkboxes, radio buttons, numerical dial, pain scales, steppers, sliders), picture, video, sound, and free-text. Question input options may be either pre-determined (e.g., radio button) or variable but may require a specific response (e.g., a numerical sliding scale). In some embodiments, there may also be provided free-text question input options.

Discrete questions may allow for various pre-set rules and algorithms to be applied against the selected answers. Meaningful insights may be derived from the collection of structured answers, such as frequency of symptoms. Various statistical analysis techniques may be applied, for example, to determine the efficacy of questions, etc.

As an example discrete question, according to some embodiments: Please take a look at your surgical wound. Are any of the following present? Select all that apply. In this example, options provided to the patient may include: (a) my wound is red; (b) my wound is draining pus or fluid; or (c) my wound is open.

Each of these possible options may have a corresponding identifier, which when selected, will be applied against various rules (e.g., indicating a red wound could lead to an automatic prompt for the patient to call the nurse/surgeon) and analytics modules (e.g., determining the frequency of a red wound during the first day after surgery among all patients assigned the same procedure).

Within the questionnaire, each question (and its associated answer options) may exist on separate pages. This may guide patients to complete each question before moving onto the next question. The potential benefits of such an implementation, according to some embodiments, may be that: (1) less technology savvy users are more familiar with moving forwards/backwards through pages (e.g., tapping a “Next” or “Back” button) than scrolling upwards/downwards a long stream of content (a less intuitive action); (2) this system may also mimic the natural physician-patient encounter, where the patient must answer each question before attempting the next question; and (3) the system may allow the same question to be multi-purposed and associated with different questionnaires applied in various contexts and situations.

### Recommendations

In some embodiments, the system processes the answers recorded by patients through a recommendation engine module. At each completion of the questionnaire, the answers are submitted to a recommendation engine and the answers are processed using various rules, which subsequently generate a recommendation for the patient user.

Each possible answer option may be associated with no rule, or one or more rules. Rules may be a single or group of logic statements that, when various conditions are achieved, trigger a specific recommendation. These logic statements can relate to one or multiple selected answer choices for the various questions. The rules are used to flag patient responses that are outside the normal range. The logic statements may further be applied to known information about a patient's condition.

The following is an example of a rule where there is only a single answer involved:

A question is asked: What is your temperature today? A temperature sliding scale may be provided, which may also be interactive, to so that the user may provide a structured, discrete response indicating a particular temperature.

A rule may then be applied: if temperature is greater than 101.5 degrees Fahrenheit, then the system has been triggered to issue a recommendation that the patient call the hospital as soon as possible.

The system may also be configured to account for rules that involve a combination of answers. For example, a patient could provide the following two answers: (a) patient user reports temperature of 102.5 degrees Fahrenheit; and (b) patient user reports wound redness.

The system could then apply the following sample rule: if the temperature is greater than 101.5 degrees Fahrenheit AND there is wound redness, then trigger a recommendation that the patient should visit the emergency department.

Combination rules can include a variety of combination types, including, but not limited to: combinations of answers within a single entry (e.g., fever and wound redness on the same day), and combinations of answers across entries (e.g., having abdominal pain of 6/10 or higher for 3 days in a row).

In some embodiments, each recommendation produced may contain a number of components. In this example, a recommendation contains three components. While the overall structure of the recommendation is pre-determined, the content delivered within these components is personalized to the patient. The recommendation may, in this example, include:

1. Recommended action: this is the overall action the patient is recommended to take, and may be, but not limited to, one of three possibilities:

a. Contact a healthcare provider—for example, call a nurse/doctor at the hospital or go to the emergency department. This information may also be personalized e.g., providing the correct phone number to call.

b. Review specific patient educational content—for example, if the patient reports mild pain, the patient can be directed to specific patient education materials on pain management from the library of educational content.

c. There are no identified concerns—in this case, no symptoms have been flagged as concerning/abnormal, and the patient should continue in their recovery as directed by their healthcare provider.

2. Symptom List

a. This is a list of the patient-generated symptoms flagged as abnormal based upon an application of a set of rules. These lists may be provided, for example, so that the patient can develop an understanding of the reasons for the recommendation.

The symptom list may be configured to provide additional context for the patient, as well to understand the issue. For example, if a patient reports a red wound, the symptom list may also be configured to inform the patient that 95% of other patients with the same procedure/clinical condition also report high temperature and that it is normal for the first few days. Such an indication, for example, may be based off aggregate data collected in the system.

3. Additional Instructions (Optional).

a. This can include any additional instructions for the recommendation, such as specific instructions on what information to tell the healthcare provider—e.g., “When you speak to your surgeon, make sure you remind them of the date of your surgery, your surgical procedure, and the symptoms you reported today.”

Recommendations may also be prioritized depending on the set of rules applied. These recommendations may be tailored also based on the particular modality for the communication, for example, a recommendation being provided over a telephone may be configured differently than a recommendation being provided over a web interface or a mobile.

The recommended action, in some embodiments, may not be a diagnosis or definitive treatment recommendation, as such a decision, in some situations, may only be made by a healthcare professional. Rather, the recommendation engine may be configured to triage the patient-generated symptoms and determines the most appropriate recommended action based on the rules developed by healthcare providers.

In some embodiments, patient instructions may consist of static if/then instructions for the occurrence of a single flagged symptom. For example, an isolated fever with a temperature over 101.5 Fahrenheit may require a phone call to a surgeon but isolated chest pain would require a visit to the emergency department.

The recommendation engine may need to also take into account for the common occurrence of a combination of a symptoms, which could suggest contrasting recommendations (e.g., phone call vs. emergency room visit), and it would not make sense for the patient to perform both.

There may be a hierarchy among types of medical encounters in the healthcare system, where an emergency room visit is for urgent concerns, a clinic visit is for medium level concerns, a phone assessment/clinic walk-in is for minor concerns and patient self-management is for very minor concerns. The benefit of the hierarchy is that each higher level type of medical encounter is capable of solving medical concerns that would normally go to lower level concerns. For example, a visit to the emergency room would address both the chest pain and a fever.

Therefore, the system may be configured to apply a prioritization process where when there are two conflicting recommendations, only the highest priority recommendation (typically emergency department visit>phone call to nurse/surgeon>walk-in clinic>review patient education>no identified concerns) will be displayed.

As indicated in an earlier example where a patient reports a temperature over 101.5 Fahrenheit and chest pain, the system may trigger the recommendation of a phone call to the surgeon due to the temperature but chest pain should trigger the recommendation that the patient visit the emergency department.

In this scenario, it may not make sense for the patient to make both a phone call and visit the emergency department, and as a result, the patient is only provided the highest priority recommendation, which would be the visit to the emergency department. In some embodiments, where a patient is provided with a recommendation above a pre-determined priority level, the patient's data may also be sent to a healthcare provider. The healthcare provider may then use this information to further the care of the patient, for example, calling to follow up with the patient or using the information so that the provider is better prepared for a visit from the patient.

### Educational Content

Educational content refers to materials or documentation related to educational topics that may be relevant to the patient user's recovery process and self-management related to a medical condition/procedure e.g., after surgery. Each of these educational topics may be specified as individual elements and each piece may contain a specific topic for patient education, e.g., pain management or wound care. The educational content may be comprised of a variety of different content, including documents, interactive pages, images, videos, etc.

In some embodiments, educational content may include relationships between various documentation and treatments or other educational content, and may be organized in various hierarchical levels.

Multiple elements together form the educational content that may be related to a procedure. In some embodiments, these elements are provided with or contained in a procedure.

For example, smoking cessation and dangers of smoking are two distinct elements of educational content within the educational content for a lung surgery procedure.

Each element may have a corresponding identifier. Educational elements can be shared between procedures and can be in multiple procedures at once. Educational elements may include one or a combination of text, image, audio and video. These elements may be organized into groups with various numbers of levels of parent groups. The elements may be organized in terms of “libraries”.

A non-limiting example of educational content topics for a lung surgery procedure—each of these topics may be supported by various material and documentation related to the specific topic:

Diet
Food
   Week 1 nutrition
   Week 2 nutrition
   Week 3 nutrition
Drink

Activity
Exercises
Bathing and Hygiene
Returning to work

Wound Care

Medications
Medications for constipation
Medications for pain management

In some embodiments, the division of educational content into elements with individual reference identifications allows for the provisioning of specific education topics relevant to the patient's immediate needs through the recommendation engine. The system, according to an embodiment, would then be configured to allow the patient education for a particular period to be personalized to a patient's current needs.

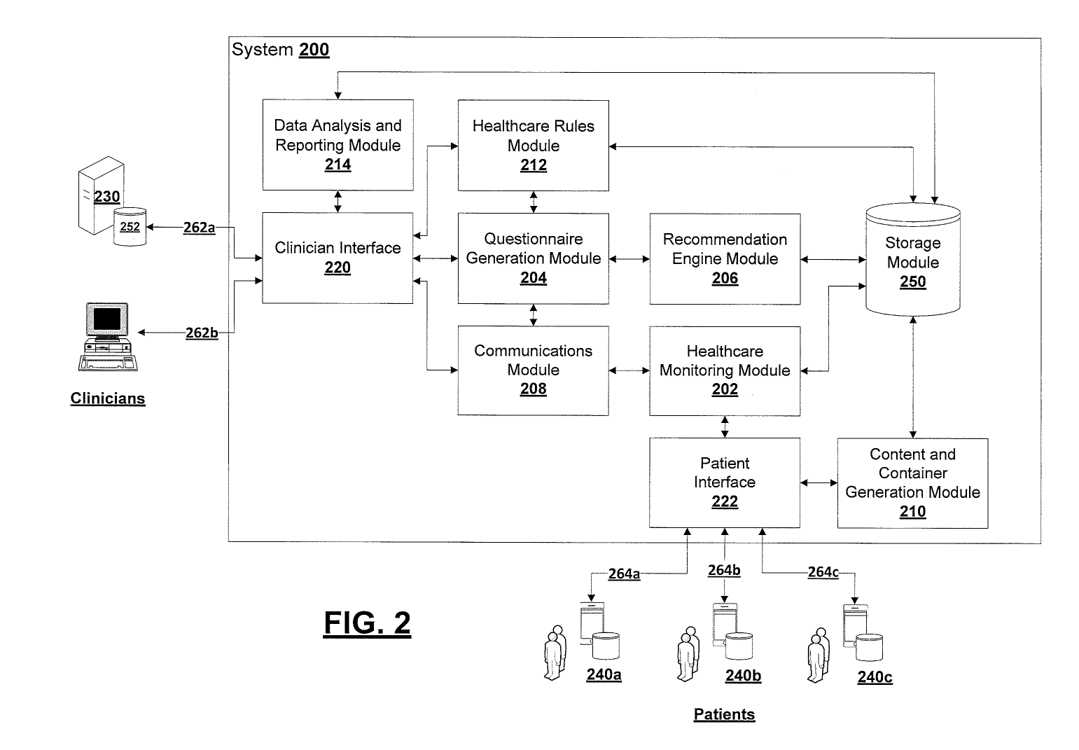

Referring now to FIG. 2, a representative block diagram may be provided illustrating system 200, according to some embodiments. It should be understood that the system 200 as depicted is merely provided for illustrative purposes and may have more, or less modules and the modules may vary in their functionality or in how the functionality is implemented.

The system 200 may be comprised of a healthcare monitoring module 202, a questionnaire generation module 204, a recommendation engine module 206, a communications module 208, a content and container generation module 210, healthcare rules module 212, a data analysis and reporting module 214, a clinician interface 220, a patient interface 222, and a storage module 250.

The system 200 may interact with one or more healthcare systems 230, the healthcare systems 230 may also include storage modules 252. The system 200 may further interact with patients through applications stored upon their mobile devices 240, as indicated by 240a, 240b and 240c. The mobile devices 240 may have computer-readable storage media either contained inside the mobile devices 240 or connected to the mobile devices 240. The mobile devices 240 may further have one or more sensors provided on the mobile devices, such as accelerometers, microphones, cameras, etc. and may further be connected to one or more peripheral devices, such as thermometers, pulse oximeters, etc.

In some embodiments, some or all of these modules may be implemented using a various elements of software and/or hardware. For example, one or more modules may be represented as a set of instructions adapted to be executed by one or more processors.

The healthcare monitoring module 202 communicates with the patient interface 222 to receive data inputs from the patients 240. The healthcare monitoring module 202 may be configured to monitor the status of a patient's account, and based upon the application of a set of healthcare rules, initiate or execute a number of various actions related to the healthcare of a patient. Where the healthcare monitoring module 202 determines that a patient may require medical assistance, the healthcare monitoring module 202 may be configured to provide notification to clinicians or administrators through the communications module 208. For example, the healthcare monitoring module 202 may be configured to provide various outputs and receive various inputs throughout the post-operative lifecycle of a patient recovering from surgery.

The healthcare monitoring module 202 may interact with the patient's information as stored on the storage module 250 to update the patient's information, when received, or to receive information used in the application of rules based upon the patient's current condition.

The healthcare monitoring module 202 may be configured to provide various outputs and guide various interactions during the period at which a patient uses the system 200. The healthcare monitoring module 202 may, through the patient interface 222 and based upon a set of rules, provide various guidance, questionnaires, or educational materials to a patient.

The patient may provide information to the healthcare monitoring module 202 through the patient interface 222, such as answers to questions from questionnaires, indications of the patient's progress in healing, whether the patient has encountered any issues, etc.

In some embodiments, the healthcare monitoring module 202 may provide tracking, active or passive, with the use of onboard sensors on a mobile device 240 or terminal if the patient enables their access on the device. This may facilitate the ability of healthcare providers to track patients if they want that location information to be shared. Data tracking may for example, include any potential access to sensors on a mobile device 240 such as a GPS, accelerometer, pedometer, barometer, compass, etc.

The questionnaire generation module 204 may be configured to develop questionnaires and/or to provide these questionnaires to the recommendation engine module 206. The questionnaire generation module 204 may be configured to communicate with clinicians and healthcare systems 230 through the clinician interface 220. The questionnaire generation module 204 may receive data sets containing questionnaire information directly form healthcare systems 230, or questionnaires may be generated based upon inputs from clinicians through the clinician interface 220.

The questionnaire generation module 204 may further be configured to iteratively develop questionnaires over a period of time through an iterative “vote up” and “vote down” system whereby various clinicians and/or experts would be able to indicate whether certain questions are relevant (or more relevant) as compared to other questions. Clinicians would also be able to suggest questions to be added. Questions and questionnaires related to or generated from the questionnaire generation module 204 may be stored in storage module 250.

In some embodiments, an expert panel methodology may be implemented, whereby the questionnaires and their related rules may be generated through an automated or semi-automated collection of insights from a variety of selected experts on a variety of subject matters. Insights may include, for example, various rules, or various questions and various recommendations.

These insights would then be presented back to the experts, who then re-gather these opinions and, through an automated or semi-automated process, include or exclude various insights over an iterative process. For example, the insights may be included or excluded based upon a consensus requirement or a minimum percentage of votes.

The recommendation engine module 206 may be configured to receive information related to a patient's status and in response to a patient's answers to questions from the storage module 250 and apply a set of healthcare rules from the healthcare rules module 212 to determine recommendations tailored to the circumstances of a patient. Recommendations include both general and specific recommendations, general recommendations being recommendations related to the type of procedure overall, and specific recommendations based upon particular attributes of the patient or care instructions from a clinician. The recommendation engine module 206 may be configured to tailor the set of questions to be provided to a patient, depending on the circumstances of a patient. For example, a patient with diabetes, between the age of 50-70, and male, may receive treatment for a kidney stone. The set of educational materials, recommendations, questions to be given the patient may be tailored by the recommendation engine module 206 when healthcare rules are applied to the patient's healthcare information as stored in storage module 250.

Recommendations may be generated at various times; in some embodiments, the recommendation engine module 206 generates recommendations after a patient completes a questionnaire—the patient may then be directed, through either a patient interface 222 or their mobile application 240 to either do nothing or to perform a particular action. The recommendations may also provide a short summary of the rationale of why a particular action was recommended.

Recommendations may take into account how many days have elapsed since treatment, and continuous trends may be taken into consideration as well. For example, when symptoms are reported repeatedly (e.g., pain scale reported 7 days in a row as to be over a certain value), the repeated reporting will result in a different type of recommendation than reporting of the same symptom 6 days in a row. In some embodiments, recommendations may have a higher priority assigned in response to detected trends.

Recommendations may also be linked with a priority—the prioritization of recommendations may be utilized and useful when conflicting recommendations are issued, or if particular recommendations overlap with other recommendations.

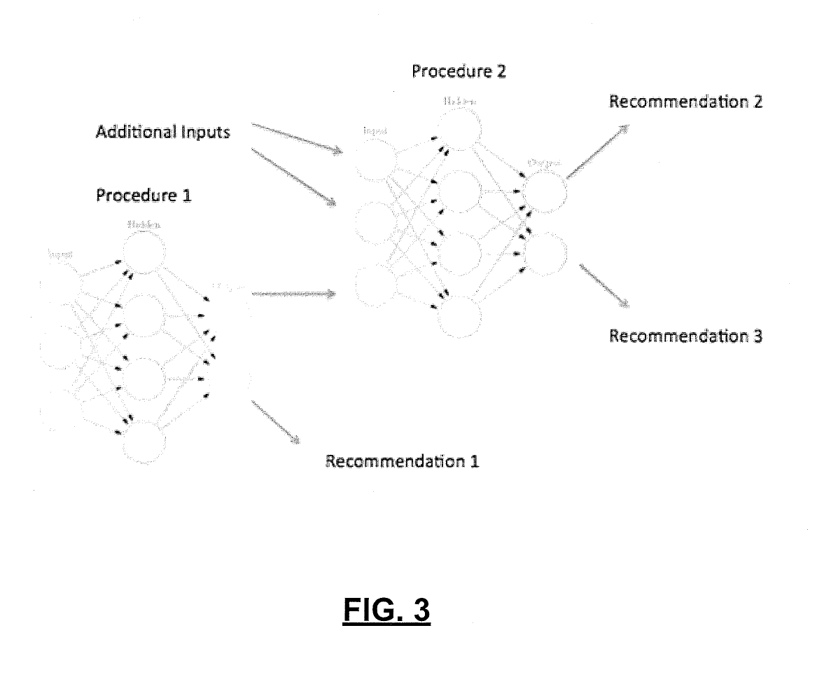

FIG. 3 provides a sample diagram illustrating the relationships between inputs, such as patient data and question answers, and recommendations. In this sample, non-limiting example diagram, various inputs, such as healthcare data relevant to a patient, and patient answers to questions are mapped to recommendations through the use of clinician-set rules or parameters, and rules related to a particular procedure or ailment. As indicated, the relationships may be complex and multiple inputs may lead to one or more recommendations.

The communications module 208 may be configured to provide communications means between clinicians and patients. The communications means may be implemented through various means, ranging from providing simply a set of contact information for clinicians (e.g., you may reach your care team at 416-555-5555), or more sophisticated implementations such as enabling instant messaging or electronic messaging capabilities. The communications module 208 may be utilized by the system 200 in various situations, including, but not limited to, indicating that an emergency situation may be occurring, the clinician asking a patient questions, a patient asking a clinician a question, etc. The communications module 208 may also initiate messages and reminders by utilizing various systems, such as email, SMS, etc. In some embodiments, the communications module 208 may be able to transmit video or photographic information.

The communications module 208 may be configured to facilitate communications with patients across various modalities (modalities being the number of devices/mediums that the patient user interacts with the system through, for example, a mobile application) and/or clinical use cases. For example, the communications module 208 may be configured to utilize various elements of information stored in electronic datastores (e.g., storage module 250) having, for example, a clinical profile reflective of characteristics of (i) the patient; and (ii) clinical treatment undergone by the patient.

For example, the demographics of certain groups of individuals (e.g., lung cancer patients as opposed to plastic surgery patients) can be substantially different, demographic information such as average age, access and proficiency to technology, accessibility, and other social economic status, may vary.

In some embodiments, the communications module 208 may be configured for a multimodal approach for delivering services across a spectrum of clinical use cases.

The modalities associated with a particular patient can be stored in a profile associated with the patient. In some cases, the modalities or a default set of modalities may be automatically determined based on the type of procedure, demographics related to a procedure, other information provided in the patient's profile (e.g., age, area code, gender, occupation, insurance status). The modalities may be dynamic, for example, where a patient updates his/her profile and/or moves to a rural location.

When a patient sets up a profile initially upon enrolment into the platform, they may, for example, provide basic contact information (phone number/email) or this information that can be retrieved from an EMR (Electronic Medical Record). Additional parameters such as age, gender can be added. A number of additional “patient caregivers” can be associated with a single patient, the patient caregivers receiving the same information as the patient but referred in text in third person (e.g., instead of saying “It is your surgery tomorrow”, a message may be instead “It is patient X's surgery tomorrow”).

The communications module 208 may be configured to determine the optimal initial setup modules to use to engage patients. If a patient provides both a phone number (that can receive texts) and email, the system will send them an invitation to start the program through SMS and email. If in the case that the phone number is a landline and cannot send texts, the system will auto-detect and fallback to using IVR (automated voice) to provide the invitation. Once invited to the program, patients may be provided a sign-in identity (e.g., email or phone number along with a password) that the patient may use to login to the platform and/or access the patient's profile.

The patient user can then “activate” a number of devices they might have that are compatible with the platform using the same identity. In some embodiments, when a patient logs in to using a new platform/device, it may be automatically added to the patient's device profile. A patient's device profile can consist of any permutation of available platforms compatible with the system, such as but not limited to: SMS (Text), e-mail, IVR (Automated Voice), web application (accessible through desktop/laptop/mobile internet browsers), tablet application, smartphone application and wearable/smart watch applications. The specific combination the patient's device profile determines how the system engages patients and what information is shown.

A response profile may be maintained by the system (e.g., in storage module 250) reflective of characteristics of responses by the patient to past communications transmitted by the system.

A communication modality profile reflective of characteristics of one or more communication channels or devices available for transmission of communications to the patient may be maintained by the system (e.g., in storage module 250), the communication modality profile maintaining information related to communication interfaces associated with communication channels or devices. These communication modalities and/or communication channels or devices may be used for transmitting various recommendations, and the selection of which channel, modality and/or device to engage may be based on, for example, (i) the clinical profile and (ii) the response profile.

As an example: A more elderly patient that only has access to a landline will have a device profile of only a “phone”. The system may provide various functionality through automated voice, e.g., converting educational notifications to automated voiced messages. A younger, more tech savvy patient might have multiple devices part of their “device profile” such as both text messages and a smart phone. The program may instead use the smart phone's mobile application as the primary modality of the program and text messages as a secondary modality. In this case, text messages may be sent to the patient to inform them regarding specific education available (e.g., providing a link directly to the app) which will open up the corresponding page in the application that could include, for example, in-depth photo/picture diagrams, video and other forms of multimedia that would be optimized to the smart phone. In this case, both types of patients are included in the program, but the experience has been optimized for the devices they have and the system is capable of taking advantage of each the capabilities of each of their associated modalities.

For each clinical use case, there may be an optimal “device profile” where the system may be configured to recommend a certain device be used for a treatment program. The determination of an optimal “device profile” may be configured to factor in, for example, social economic status and/or age/condition. For example, where the patient is using the platform to recover from a hip/knee surgery, the system may be configured to recommend to the patient to at least use a mobile application on a tablet.

As an example, lung surgery patients (e.g., which may tend to be older [over 60]) that are past a certain age might be recommended to only use the SMS (text message program) instead of using an online web application. Providing instructions on how to use the web application may potentially confuse a patient and the system may be adapted to optimize for the modality that the patient may be familiar with. For example, the program may be configured to switch into a text message only mode where the program will be specifically tailored to text messages. Various elements may also be tailored, such as the provisioning of the types of message, frequency, message content, additional features available on a particular modality, etc.

As another example, plastic surgery patients may be generally younger and more tech-savvy. In this case, an optimal modality might be a mobile application.

“Device profiles” may be updated over time (e.g., does not require the user to have all devices setup in a limited time frame). For example, a patient could potentially activate a smart watch they recently bought halfway through their time on the platform. Activating any new device may cause the updating the device profiles in real-time or near-real time. For example, with an activated smart watch, one or more patients may start receiving reminders on their watch about the program instead of on a smartphone's notification screen.

Over a period of time, based off of various metrics and measurements collected regarding how patients are engaging with the program (e.g., based off of how many times the patients are signing into applications, response rate to notifications/tasks) the system can optimize the optimal modalities for engaging the patient. If a patient has low engagement and has multiple activated devices, the system may be configured to cycle through and test which modality has the highest engagement numbers (by tracking which modality has the highest response rate to messages (by opens or clicks) and change the primary engagement modality as necessary. For example, patients that don't respond to email reminders in a timely manner might start getting pushed text messages. The rules around cycling may also be adapted based on information received at a population or group level. For example, if the system recognizes that a particular approach is effective for a particular demographic or people afflicted with a particular condition, it may prioritize modalities related with those approaches first.

The content and container generation module 210 may be configured to generate both content and container sets. The generated content may include the generation of “procedures” that contain a set of rules, questionnaires, education, recommendations, etc. used to provide support for a patient who satisfies certain criteria (e.g., has diabetes, had facial surgery, is malnourished).

When a patient user is assigned a procedure, the system interprets various properties of the patient user to activate or deactivate specific functionalities in each element, thereby generating a potentially relevant and focused workflow/data processing structure for each element in a manner that is tailored towards the patient's circumstances. The procedure, and the elements within it, may be have various functionality activated or deactivated based on patient variables and patient-generated data. The content and container generation module 210 may tailor content by applying a set of logical rules derived from the healthcare rules module 212.

Procedures may include an auto-end feature that can be set specifically for each procedure/hospital implementation (e.g., 40 days after surgery). This can be communicated through the procedure as it is fetched initially by the server or set on the device. Rules may be also configured such that after a certain number of stable symptom inputs (e.g., pain levels<2 for 20 days, no reported symptoms for 30 days consecutively) to notify the patient they are stable and that the recovery/monitoring period is over.

Patient variables may refer to variable properties about each patient that are recorded in a patient's account, such as his or her age, sex, doctor, medical condition or surgery, etc. In some embodiments, prior answers to questionnaires may also be considered.

For example, a patient assigned to a colon surgery procedure may have tailored questions included in the questionnaire, the tailored recommendations generated by the recommendation engine module 206, and educational content made available and other elements in a way that is relevant to colon surgery.

In further example, such a patient user could receive a questionnaire that contains a camera function question for taking a surgical wound photo, but a patient assigned to a diabetes procedure could receive a questionnaire that does not contain a camera function question.

Patient-generated data refers to changes in the patient's clinical signs/symptoms that the patient reports during the course of utilizing the patient interface 222 or on their mobile device 254. Similarly to patient variables, changes in the patient-generated data can result in additional activation or deactivation of functionalities within the other elements.

For example, if the patient records the presence of a wound problem for a specific question in the questionnaire, then the camera function question could be activated as the next question, but if the patient did not record a wound problem, then the camera function question would not be provisioned.

The assigned procedure may be delivered through the patient interface, which, for example, may be implemented as a web server, in the form of standardized machine-readable instructions, which may then be rendered in the mobile application.

Containers encapsulate one or more procedures and may be generated on a patient-by-patient basis depending on his/her particular needs. In some embodiments, containers may be designed to act as a “stand alone” health platform by providing all the logic, workflows, materials, questionnaires, etc. to help a particular patient monitor his/her care after leaving the hospital. A potential benefit of utilizing containers configured in this way is the ability to provide care through an application without a constant internet connection, which may be especially advantageous when providing services to individuals who live in remote areas; data would be available both on the server and available locally on a patient's terminal. Another potential advantage is the ability for the patient to receive monitoring and notifications even if there is a service outage at the server. Additionally, the container structure may be beneficial for an implementation in a healthcare setting, as there is only one single “application” to distribute—lowering the complexity of handling multiple use cases.

In some embodiments, the application may provide an initial communication with the server, where the application accesses and downloads the appropriate container set which encapsulates the relevant procedures, questions, answers, recommendations, rules, and features, tailored based upon the application of various rules related to a particular patient's healthcare needs.

The downloaded data in the container may be representative of the functionality of the application. The downloaded data may be comprised of: (1) questions/answers, (2) education elements; (3) recommendations and results/outcomes; (4) rules which provide associations between the various questions/answers, education and recommendations, and may also capture logic that may be applied based upon information known about a particular patient or procedure; and (5) any relevant patient data that may be utilized by the system.

In some embodiments, the content and container generation module 210 is invoked upon the adding of a new patient to the system 200 or when a procedure is added to the care of an existing patient. When one of these events is detected, the content and container generation module 210 may generate a container to be provided to the patient's terminal or mobile device.

As different hospital sites and different clinicians can have potentially different workflows and special considerations, the specific components may each be customizable. For example, a hospital or clinician may choose to customize how each component interacts with hospital/patient properties (as passed along from the procedure) so that they can be utilized in any of the procedure components.

For example, recommendations can reference surgeon names such that while it may be the same procedure being provisioned to every person going through that surgical procedure, each patient might have custom recommendation messages referencing their own surgeon. This may also include more personal instructions, such as who to contact when a concerning symptom is reported as well as what specific number to call.

The healthcare rules module 212 may be configured to develop, maintain, and/or update a set of rules related to the healthcare of patients, the set of rules being stored in the storage module 250. The rules may be developed to be applied at various levels of generality, for example, rules based upon all patients meeting one or more criteria (e.g., patients with diabetes, patients who underwent fracture surgery, patients who are of a particular ethnicity, patients with a BMI above a particular number, time elapsed after surgery).

In some embodiments, the set of rules is represented by sets of computer-readable instructions or computer code that may be executed by a processor in relation to healthcare data stored on storage module 250.

The healthcare rules module 212 may be configured to receive inputs, through the clinician interface 220, from clinicians or healthcare systems 230. The healthcare rules module 212 may also be configured to transmit representations of the existing healthcare rules on system 200 to clinicians through the clinician interface 220. For example, the healthcare rules module 212 may import in a set of rules from the healthcare systems 230 or, in some embodiments, provide a listing of the current set of rules for users to view and manipulate through the clinician interface 220.

For example, clinicians may set rules to indicate specific cases for which to be notified (e.g., if certain reported symptoms go into a specific range). Notifications are implemented through communications module 208 that may be configured to send the relevant information to the appropriate individuals through any number and/or combinations of mediums (e.g., SMS, email, and/or IVR).

The rules for each procedure assign severity levels to various elements of information. The rules may then apply business logic that treats information differently depending on severity level. For example, information that is less urgent is provided on an aggregate table format through the link sent to the provider while urgent concerns may be directly encapsulated into the notification. Urgent information may be indicated to the relevant parties as determined by the severity levels assigned from rules and distributed through the notification system.

The following examples of healthcare rules and their applications are provided for illustrative purposes:

### Example 1

Patient reports through the system that they are experiencing breathing difficulties with walking (a relative minor issue) for a day. Based on the rules, the severity of the reported symptom is minimal and would not trigger a notification to the healthcare provider. Instead, the patient receives a recommendation to review educational material (breathing exercises) to better help their breathing recovery immediately and automatically, a result as defined by the rules.

### Example 2

If a patient reports vomiting for two days in a row (a more severe issue), the assigned healthcare provider contact will be notified through the system with email/SMS/IVR about that patient based off the assigned severity level of the symptom from the rules. The electronic notification includes succinct details of the nature of the concerning issue along with further instructions (e.g., a link) to access the full range of reported data. The patient will automatically receive a recommendation based off the rules at the same time (without intervention from the healthcare provider) on instructions on what they should do (which might be access to a phone number to contact the correct healthcare provider).

Designated points of contact may be pre-defined in the system (e.g., a nurse, a doctor). There can be multiple points of contact for a single procedure recommendation and all, one, or none could be shown in a recommendation to have the patient contact.

For example, a lung surgery procedure at a hospital could have a doctor contact, a nurse contact, and a hospital telephone line operator contact. Each contact can have a range of times they are available, e.g., the doctor is only available in the morning, nurse in the afternoon, and the operator at any other time of day. If a patient reports/inputs data in the morning and the recommendation is one that asks him to call in, the appropriate contact is shown (depending on what time of day it is). In this case, since the doctor contact has been defined in the system to be available, they would be the contact that is shown to contact in the recommendation. This is an example of the rules that may be provided to the recommendations engine module 206 to take into account hospital workflow procedures and available resources.

In another embodiment, available or unavailable resources (contacts) could change (a doctor becomes unavailable) and the system may be able to determine, through communication between the system and a hospital information system, the next contact as defined by a prior rule set.

In some embodiments, machine learning components can be integrated into the healthcare rules module 212. Reported symptoms/parameters can be matched to previous cases of known outcomes of patients previously in the system. Rules can be represented as a decision tree or neural network (data structures that machine learning techniques can be applied upon) with their weights influenced by training on the existing data set. For example, there may be the construction of a classification and regression tree based off of reported symptoms from a specific procedure.

The healthcare rules module 212 may further be configured to apply rules to determine when a patient has been inconsistent with reporting and/or answers.

The data analysis and reporting module 214 may be configured to provide analytical decision support to clinicians through the clinician interface 220. In some embodiments, the data analysis and reporting module 214 may be further configured to provide information to an external system, through an API.

The data analysis and reporting module 214 may be configured for various tasks, such as keeping track of usage data, conducting statistical analysis on patient and/or usage data, developing report views, among others. Through the clinician interface 220, clinicians or administrators may be provided with a dashboard view that is configured to depict various elements of information about the system. Information about the system may include analysis such as the questions and education pieces, ranked by “usefulness”. Usefulness may be defined in the system as highly rated pieces. For questions, this includes how correlated it is to a specific patient outcome/recommendation (e.g., 50% of people who report high belly pain on the pain scale question are recommended to go to the ER).

The dashboard may be further configured to provide views of the aggregate data submitted and stored by the system. For example, the dashboard would be able to indicate and filter the data using the data itself, meta data associated with the data, and compile the data into graphical forms, such as tables, graphs, summary charts, etc. An administrator or clinician, for example, would then be able to view how successful a particular surgeon was, statistics on a procedure-by-procedure basis, frequency of symptoms, etc. Various metrics may be compiled based upon the analysis of the aggregate of data.

In determining a usefulness rating, education pieces may be rated based upon feedback on a page. The usefulness rating may allow clinicians or the system to identify low performing elements and recommend to system administrators which elements to improve.

In some embodiments, the data analysis and reporting module 214 may be configured for optimizing and/or updating various procedures related to the operation of the system.

An initial baseline procedure (questions, rules, recommendations) may be developed, generated and/or otherwise provided using various methods (e.g., the Delphi method) by clinical experts as an initial attempt.

As patients use the application over time, data, such as symptoms reported and at what time may be received and/or aggregated by the data analysis and reporting module 214. For example, other analytics data may also be used to measure and/or act upon metrics related to patient engagement:

Time patients spend using a modality of the platform

What content was viewed and responded to

As the sample sizes get large enough (ex. number of patient subjects>500) trends may be identified based on certain criteria. Example criteria may include:

Low variation questions

Frequently triggered recommendations

Highly reported symptoms and concerns

For example, after an implementation of a baseline solution, if a number (e.g., a majority) of the data points indicates that a certain questions shows little to no variation (e.g., 100% of patients don't report a symptom past a certain date), the system may be configured to identify this trend and to recommend that the question to be removed past a certain date in order to streamline the patient experience.

If the health care provider user decides to approve of the system recommendation, patients on the program will no longer see that question past a certain date. In some embodiments, the system may be configured to automatically remove the question.

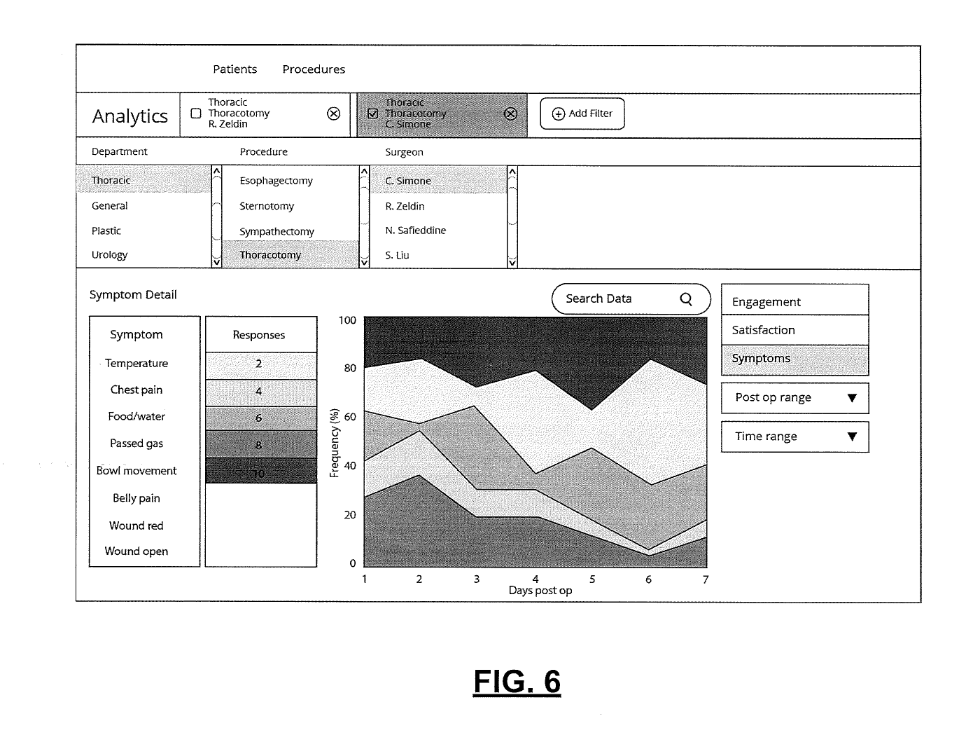

FIG. 6 provides a dashboard representation of how clinical reported data is represented and visualized, according to some embodiments.

As another example, If a certain symptom has been highly reported by patients on a certain date (e.g., 95% of patients reported nausea 2 days after surgery), the system may be configured to identify this trend and may recommend automatically sending notifications to patients 1 day after surgery, indicating that 95% of their fellow patient s reported nausea 2 days after surgery, and in addition provide the necessary precautions (educational content) on how to avoid/reduce the issues with those symptoms.

Suggestions that are identified may be changed in real-time or near real-time and the procedures may be updated through a Content Management System UI for health care providers to add/edit/delete procedure components.

The system may, for example, be configured to allow for various dynamic changes to procedures:
Showing/hiding specific questions based off what day it is past/from a specific care event (e.g., surgery date);
Prioritizing/changing order of what information patients get notified about (e.g., through text messages/emails/push notifications); and
Contextual add-ons to recommendations that takes into account patient activity compared to various baselines or norms.

In some embodiments, the system is configured to be change and update its own internal rules and logic to provide a self-assessing platform for producing dynamic sets of procedure components (e.g., questions, rules, recommendations, education, notifications, and tasks) that provide a contextual and personalized experience for the patient population.

The data analysis and reporting module 214 may also be configured to identify inconsistent inputs and provide reports that indicate variances in information provided regarding any specific symptom. This could occur, for example, if a patient reports information that is inconsistent, or indicates a particular trend, such as a worsening temperature (e.g., information may be provided as a report with a heatmap, which a clinician or administrator would be able to view on the clinician interface 220).

Elements in analytics may be linked to standard medical terminology (e.g., SNOMED, ICD), which may facilitate comparison across procedures and across hospital sites. Question/Answers also may be linked to these terms (reported vomiting in the system is linked to the standard term in ICD) as well.

In addition, usability analytics on the application may help track various interactions in order to improve usability of the application. As there are potentially multiple different types of interfaces (phones, tablets, etc.), one of the challenges is to find an optimal display and presentation given the patient population. Through recordings of interactions and various other interactions capturing, the system can identify what are the top interactions and correlate that with patient data.

As an example, patients age 50-60 may have trouble clicking on the settings button in the top right corner or zoom in a lot to a specific diagram inside the education page regarding breathing exercises. The analytics of the system can present and identify them as data points of interest. The administrators can have the system take into account these findings by having the procedure produce larger settings icons and exercise diagrams when a patient age is within that category.

The usability and analytics may be associated with and/or measured against various key performance indicators (KPIs). Example KPIs for healthcare providers may include, for example, reimbursement, cancellations, readmissions, patient satisfaction, survey data collection.

In some embodiments, the system may be configured to optimize various variables in relation to specific KPIs (e.g., the KPIs that the health care provider is interested in) through the use of a patient engagement engine that may be provided as part of the data analysis and reporting module 214.

For example, upon initial implementation of the platform solution at a healthcare provider, the health care provider may be prompted to provide the system with the KPI metrics that are the important for the system to optimize for. Current KPIs may include, for example: reducing cancellations to appointments, optimization of reimbursements, increase satisfaction response rates, and reducing readmissions. KPIs can be ranked and/or chosen in order of increasing importance (e.g., the top priority is reducing readmissions, followed by increasing satisfaction response rates). In some embodiments, weights may be associated with various KPIs in relation to their importance.

Based off of the priority of KPIs, the system may be configured to adjust how certain portions of the procedure are presented to the patient. Events (User interface elements) that are associated with top priority KPIs are considered more important and brought to more prominence within the user experience. This includes potentially:
Creating numerous automated notifications/messages for the patient
Increasing visibility of the task (e.g., making the user interface element it occupies larger, bolding the text)
Creating additional reminders embedded in other tasks

An example is provided in relation to reimbursement optimization:

By receiving and/or otherwise being provided reimbursement data from a health care providers records, such as billing codes (e.g., DSM, ICD), the system may be configured to assign specific codes to outcomes that the patient reports into the system.

Specific questions in the procedure that will help support specific billing codes can be optimized to be answered specifically and reminded early on that it is important for the patient user to respond to.

In some embodiments, increased patient engagement may therefore convert into a higher incidence of proper documentation to support specific outcomes, therefore optimizing reimbursements (both earlier and more accurately).

As a second example, satisfaction data may be optimized as a KPI. For day surgery clinics that attend to a large amount of volume of patients, patient satisfaction surveys may be an important metric to collect in ensuring their quality. However satisfaction surveys are typically hard to collect.

By embedding the satisfaction survey as part of their post-operative surgical program as an important first task to get started, there may be an increase of the satisfaction response collection rate, as compared to simply asking the patient to respond to surveys.

In some embodiments, the user interface may be configured to show embedded reminders in other tasks, to help optimize for survey response rate (e.g., a reminder to the patient satisfaction survey may be embedded into a daily health check).

As a third example, the system may be configured for optimization in relation to readmissions. In this example, Hospital A has been recently penalized $1,000,000 by an insurance body, a regulatory body or a professional body (e.g., CMS) for excess hip & knee readmissions. The system may be configured to recognize that the majority of hip/knee readmissions are due to surgical site infections, which progressed to readmissions. As a result, the system may be configured to automatically modify Hospital A's hip/knee module to start tracking signs of surgical site infections with remote wound photo monitoring, and then start alerting wound care nurses for incision concerns.

As those metrics start to change, and other metrics may pose issues (e.g., financial issues and/or outcomes), the system may be configured to re-adjust KPI optimization. For example, if the hospital starts performing safer surgery, and less surgical site infections occurs, then the system may be configured to re-adjust the module automatically and focus less on infections.

The clinician interface 220 may be configured to provide an interface to interact with administrators, experts, clinicians or healthcare systems 230. The clinician interface 220 may communicate through a networking means 262. Networking means 262 may include various implementations of communications means, such as wired connections, wireless connections, connections over the Internet, connections over an intranet.

The clinician interface 220 may be configured to provide clinicians, healthcare providers, and/or experts certain functionality, such as the ability to view procedures submitted by patients, assign procedures to patients, view analytics, and to create procedures.

In some embodiments, the clinician interface 220 may be comprised of a web interface in which clinicians are able to interact with the system 200 through an application on the Internet, which may or may not be mobile accessible. The clinician interface 220 may permit the depiction of text, photos, videos, etc. that may be recorded/uploaded by patients as answers in response to questions about their care. The clinician interface 220 may then permit clinicians to review these text, photos or videos.

In some embodiments, the clinician interface 220 may be comprised of an application programming interface (API) that provides a communications means between various machines. An API may be implemented via various technologies, such as Simple Object Access Protocol (SOAP), interfaces developing through exposing functionality using programming code, representational state transfer (REST adhering programming techniques), etc.

The clinician interface 220 may be configured to enable functionality that allows clinicians to add, modify or delete patient information, healthcare rules, questionnaires, educational materials, recommendations, among others. The clinician interface 220 may also be configured to provide various data reporting, data analysis, administrative and troubleshooting functions.

In some embodiments, the clinician interface 220 may be configured to provide one or more experts with an interface to generate content iteratively through the proposing of various questions, rules, recommendations, etc. In further embodiments, the clinician interface 220 may be further configured to provide an iterative voting process to iteratively exclude or include content over time.

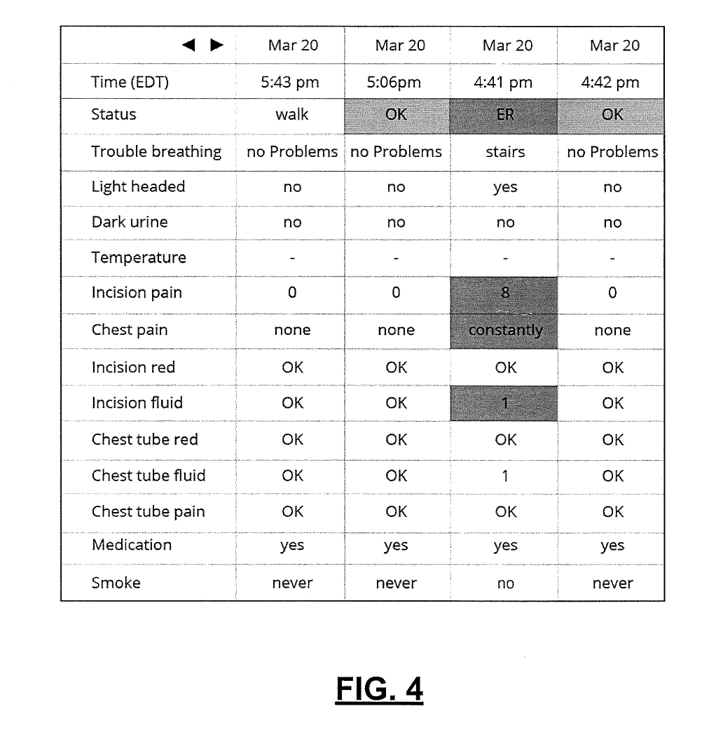

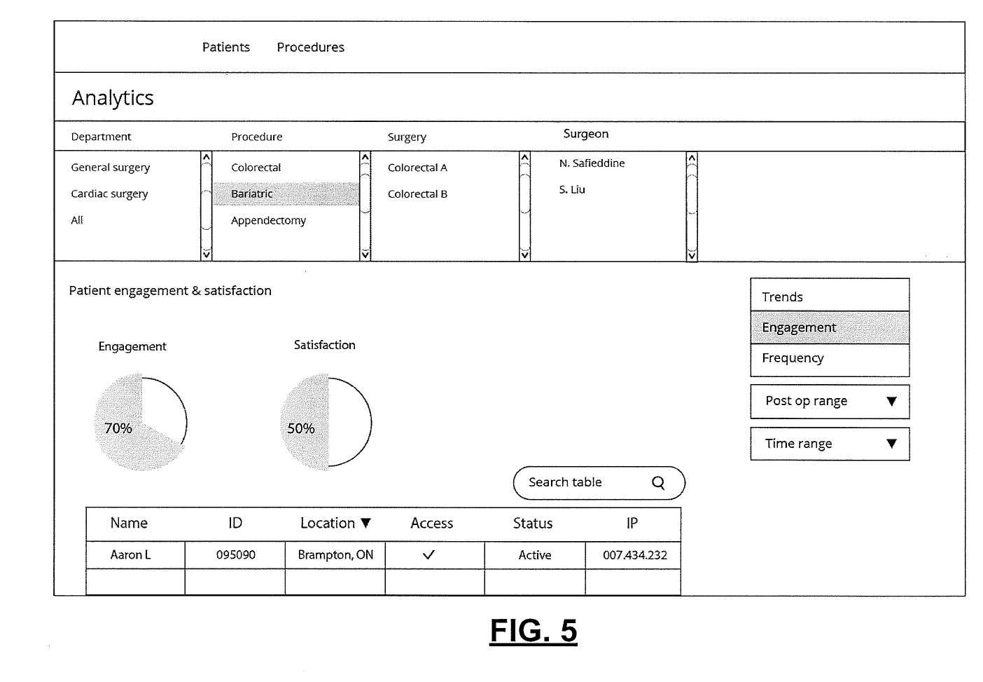

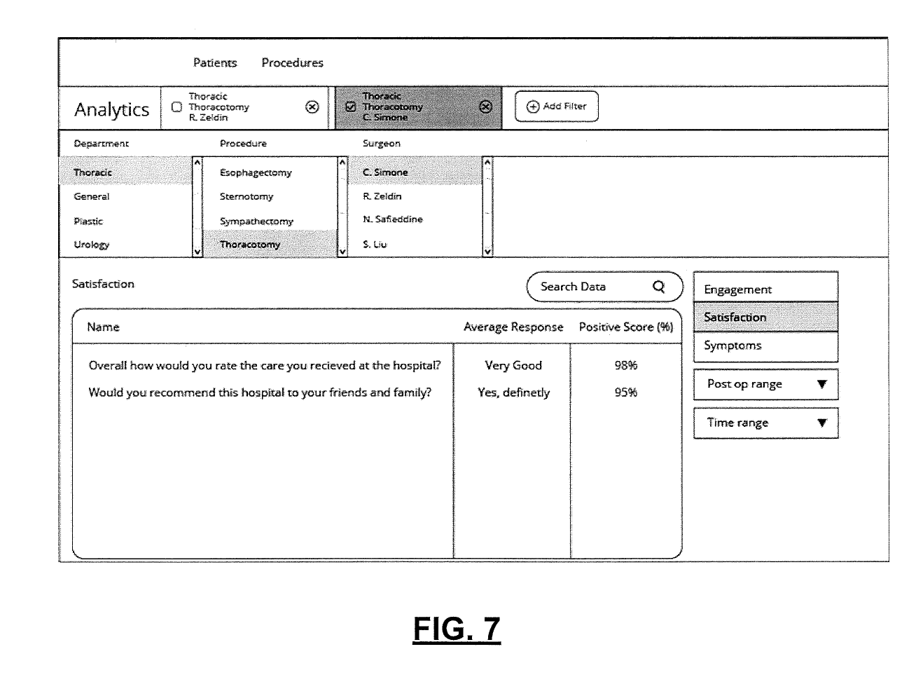

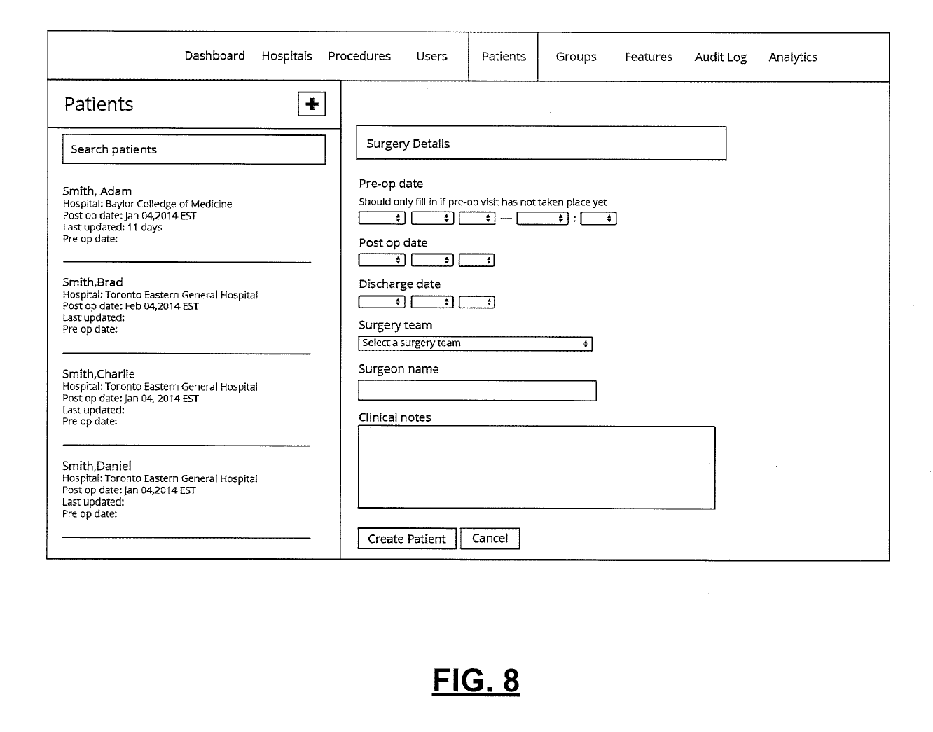

FIGS. 4-8 provide sample user interface (UI) screens of the clinician interface 220, according to some embodiments. FIG. 4 illustrates a sample heatmap indicating the responses received from a patient with respect to a procedure, and is color coded based upon a set of rules. FIGS. 5-7 provide sample screenshots of an analytics dashboard with various filtering applied. FIG. 8 provides a sample screenshot of a screen used to add a procedure for a particular patient.

The patient interface 222 may be configured to provide functionality to enable a patient to interact with the system 200. The patient interface 222 may provide information generated from the system 200 and also receive information provided by patients.

The patient interface 222 may be configured to store a profile for each patient. The profile may be stored in storage module 250, and may include any data relevant to the patient's care and any associations with various healthcare systems and clinicians. The patient interface 222 may further contain authentication functionality, such as username and passwords authentication, or any other kind of authentication. This authentication may be passed on to the mobile application on the patient's mobile device 240 so that the information on the mobile device 240 would require authorization before it is accessed by a user.

The patient interface 222 may be configured to provide the ability for patients to view procedures, submit procedures and to receive feedback from the system.

In some embodiments, the patient interface 222 may be implemented as a web portal, mobile application, or web interface. The patient interface 222 may also be configured to communicate/operate with a patient's mobile device 240. In some embodiment, the patient interface operates with a mobile application stored upon a patient's mobile device 240. In these embodiments, the mobile application accessing the patient interface 222 may be stored upon computer-readable memory located on or connected to the mobile device 240, and may be stored alongside various information relevant to the healthcare of a patient or a group of patients.

For example, according to some embodiments, the patient interface 222 provides a backend system that connects with mobile applications installed upon patients' mobile device 240. According to this example, upon a first connection, the patient interface transmits a container containing a set of tailored procedures and any other information.

The patient interface 222 may interact with patients or their mobile devices through a network 264 (shown as 264a, 264b and 264c), through a wired or wireless connection. The network may include various networking technologies and networks, such as intranets, the internet, point to point networks, etc.

The patient interface 222 may permit patients to upload media content, such as photographs and videos related to their care. For example, in response to a question about how their surgical wound is healing, a patient may be asked to upload a photo of the wound for review by a clinician.

The patient interface 222 may also provide additional features, such as the ability to view interaction logs, support multiple languages, feedback questionnaires (e.g., regarding hospital, clinicians), procedure specific functionality.

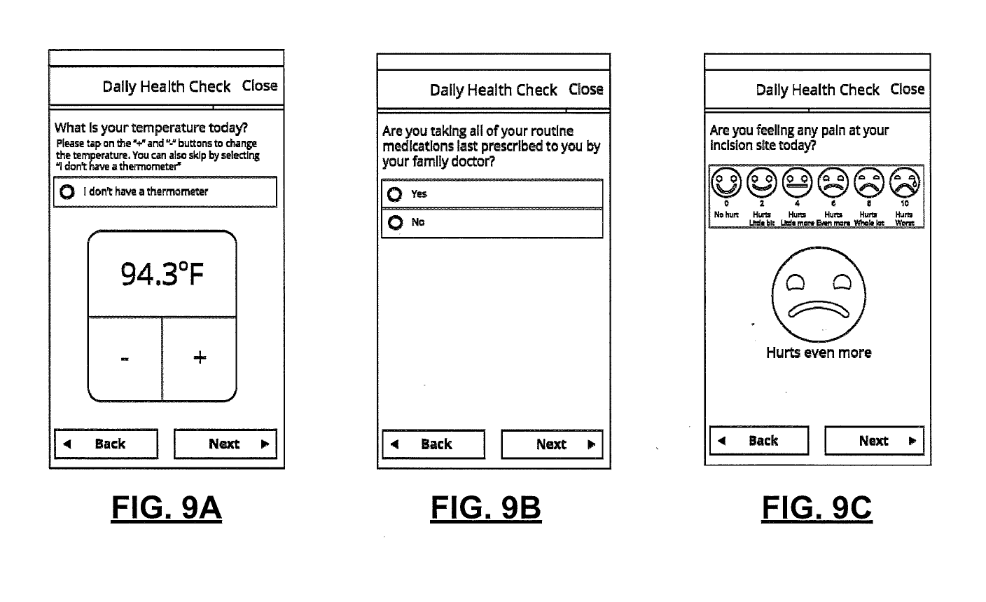

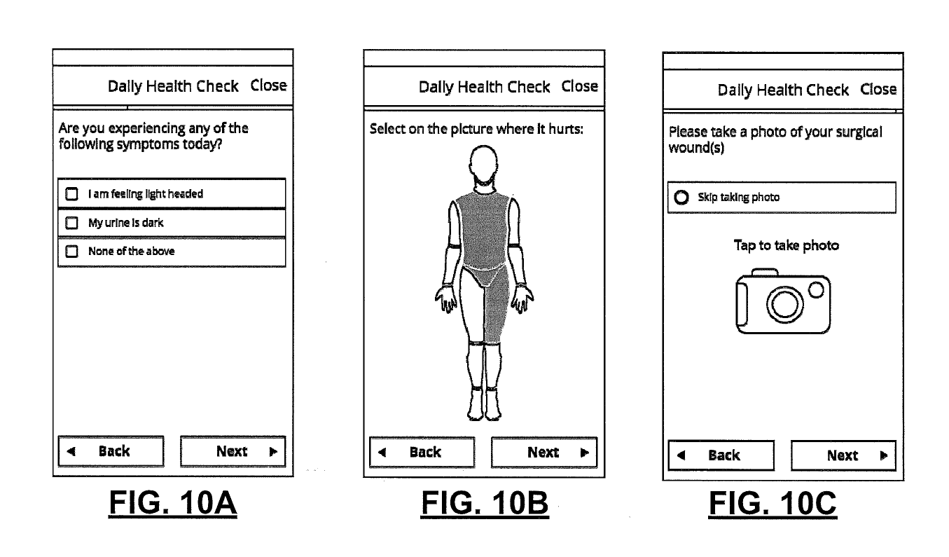

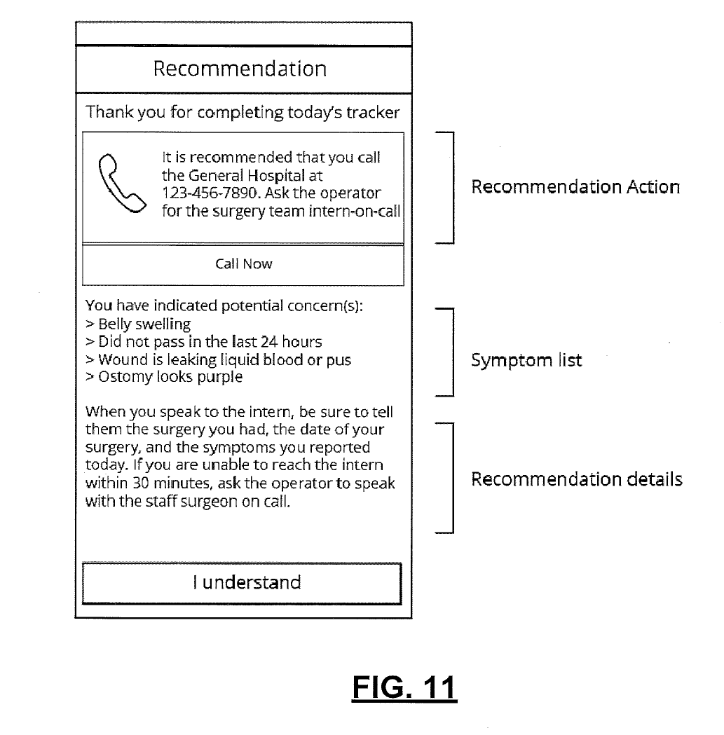

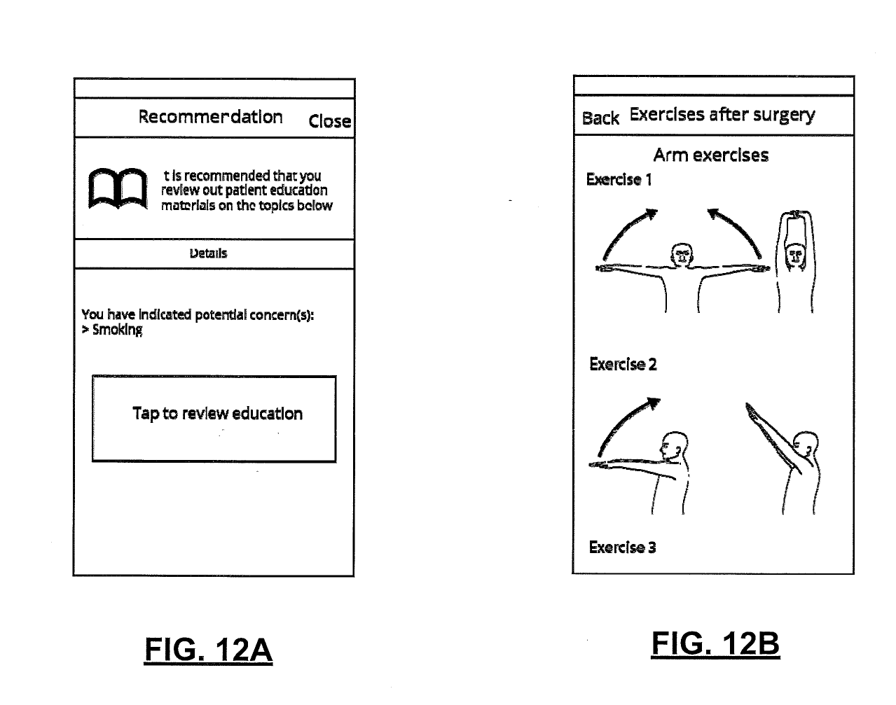

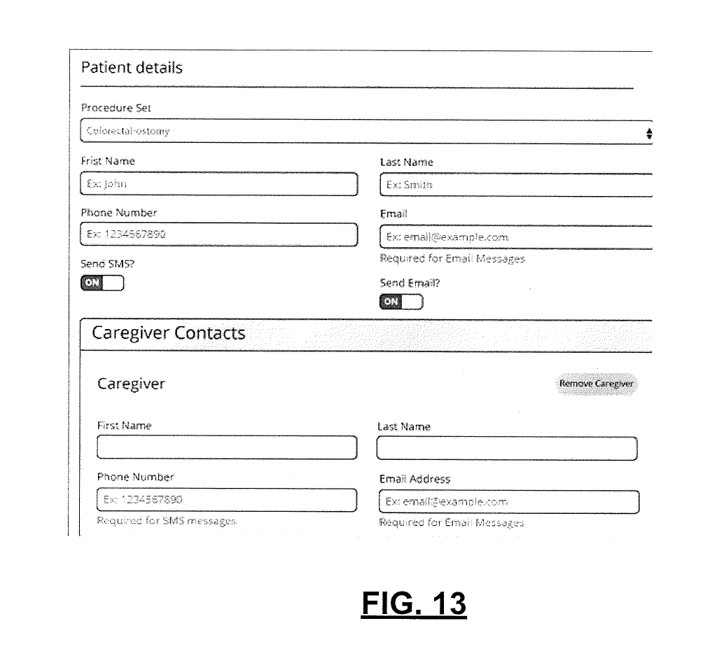

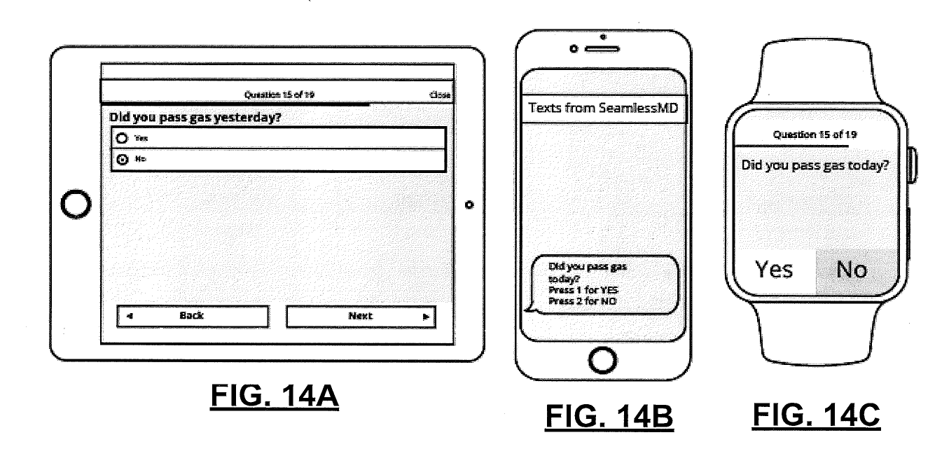

FIGS. 9-14 provide sample user interface (UI) screens, according to some embodiments. FIG. 9A illustrates an input screen where a patient is asked for and may provide his/her temperature, FIG. 9B illustrates an input screen where a patient is asked a discrete question with radio buttons for selecting a response, and FIG. 9C illustrates an input screen where a patient is able to interactively indicate the level of pain at an incision site. FIG. 10A illustrates an input screen where a patient may indicate what symptoms the patient is feeling for a particular day. FIG. 10B illustrates an input screen where a patient can indicate where the patient is feeling pain. FIG. 10C illustrates an input screen where a patient is requested and may upload a photograph of their surgical wound. The patient may also skip the step if the patient wishes to. FIG. 11 illustrates a sample recommendation screen that may be provided upon completion of all the questions for a given day. In this example, a recommended action is provided based upon the patient's answers, a symptom list is indicated summarizing the patient's answers, and a set of recommendation details are provided. FIG. 12A illustrates a sample recommendation screen recommending a patient undergo some exercises. FIG. 12B illustrates a sample education screen that provides a pictorial indication of the types of exercises that one may conduct. FIG. 13 is a screenshot of a page where a patient is able to indicate on the patient's profile various preferences in relation to methods of communication, according to some embodiments. FIGS. 14A, 14B and 14C are sample depictions of questions posed on a text only program (SMS, FIG. 14A) compared to an application on a tablet (FIG. 14B), or an application on a smart watch (FIG. 14C).

The storage module 250 may be configured to store information related to the healthcare of patients. This information may be comprised of electronic health records, patient data, logical rule sets, questionnaires, messages between patients and clinicians, patient logs, patient photos, patient videos, educational materials, diagrams, messages, metadata, relationships between different elements of data, etc.

The storage module 250 may be implemented using various database technologies, such as relational databases (e.g., SQL databases), flat databases, excel spreadsheets, comma separated values, etc. If the storage module 250 is implemented using relational database technology, the storage module 250 may be configured to further store relationships between various data records.

The storage module 250 may be implemented using various hardware of software technologies, such as solid state or hard disk drives, redundant arrays of independent disks, virtual storage devices, etc.

The present system and method may be practiced in various embodiments. A suitably configured computer device, and associated communications networks, devices, software and firmware may provide a platform for enabling one or more embodiments as described above.

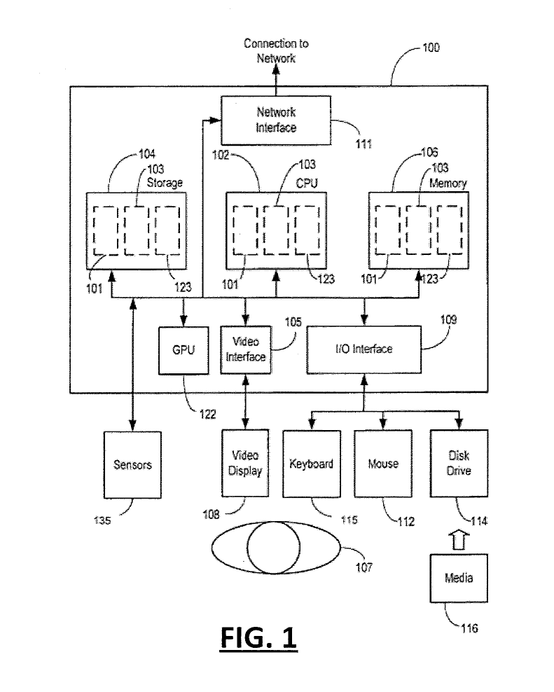

By way of example, FIG. 1 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present system and method may be practiced on computer devices including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g., an optical disc, a magnetic disk, a tape, etc.), on one or more data storage portioned of a computing device, such as memory associated with a computer and/or a storage system.

The mobile application of the present invention may be implemented as a web service, where the mobile device includes a link for accessing the web service, rather than a native application.

The functionality described may be implemented to any mobile platform, including the iOS™ platform, ANDROID™, WINDOWS™ or BLACKBERRY™.

### Sample Workflows

The following provides a description of various implementations to set up an account with the system. Setup of the application may occur in various forms—two example, non-limiting examples are provided:

1. Online setup of the account through the healthcare provider portal which allows healthcare providers to create patient accounts and assign them to the correct procedure(s). The healthcare provider would then provide the patient with the appropriate login credentials to setup.

2. Patient application setup where patients/caregivers can download the application onto their phone, input the correct credentials (e.g., A PIN to associate what hospital and procedure they a part of, which can be provided to all patients beforehand) and automatically setup an account through the patient device.

The following are sample workflows that indicate sample steps that organizers, clinicians and experts may take when creating the questionnaires, rules & recommendations. These workflows are based on the expert panel methodology as indicated earlier in the specification and provide example steps for illustrative purposes.

A list of education topics may also be generated by experts using a similar system and methodology as the questionnaire, except with a list of educational topics instead of symptoms/measures.

### Questionnaire Development

1. An organizer selects a specific medical condition or surgical procedure.

2. An organizer selects a panel of experts to participate.

3. The experts are asked to brainstorm a list of clinical measures/symptoms to be monitored for the medical condition/procedure (e.g., temperature, pain, etc.) and record these into the system (e.g., web app/software).

4. The organizer reviews the results, removes duplicates, and consolidates the measures/symptoms into a single list.

5. The consolidated list is presented back to the experts on the system.

6. The experts are asked to select which measures/symptoms should be included.

7. All measures/symptoms for which at least a predetermined majority percentage of experts agree should be included (e.g., >70%) are considered “Endorsed” and retained for the next round. All measures/symptoms for which less than the predetermined percentage of experts agree should be included (e.g., <70%) are considered “Excluded” and removed from consideration.

8. The measures/symptoms that make the next round are then ranked for importance of inclusion using a scale (e.g., 1 to 10) by the experts.

9. The top X (e.g., top 10, where X is defined by the organizer) measures/symptoms with the highest ratings make the final list to be included in the Questionnaire.

### Rule Development

1. The final list of measures/symptoms are presented back to the experts, and for each measure/symptom, the expert is asked to provide a threshold or rule for which that measure/symptom is considered abnormal (E.g., #1 for the measure temperature—a proposed rule of if temperature greater than 101.5 Fahrenheit. E.g., #2 for the measure pain—a proposed rule of pain that is at least 7/10 for 3 days in a row, etc.)

2. The organizer reviews the results, removes duplicates, and consolidates the rules into a single list.

3. The consolidated list is presented back to the experts on the system

4. Each expert must select the best rule from the list available for each symptom

5. All measures/symptoms where there is a rule for which at least a predetermined majority percentage of experts (e.g., >70%) agree are considered “Endorsed” and make the final list

6. For all measures/symptoms where there is no rule for which a predetermined majority percentage of experts agree (e.g., there is no rule for temperature that >70% of experts agree on), rules that had at least Y % (e.g., 30%) agreement from experts will be re-rated in the following round, whereas rules with <Y % agreement will be Excluded.

7. The rules to be re-rated undergo Steps 3 to 6 until majority agreement is reached on the rule to be Endorsed for each symptom/measure in the Questionnaire.

### Recommendation Development

1. The final list of measures/symptoms and their associated rules are presented back to the experts, and for each grouping, the expert is asked to provide a specific recommendation, from among: 1) go to the emergency department; 2) contact a health care provider; 3) review relevant patient education (and other potential recommendations)

2. All recommendations for which at least a predetermined majority percentage of experts (e.g., >70%) agree make the final list

3. For all recommendations where <X % agree, recommendations that were selected by at least Y % enter into consideration to be re-rated in the following round, and only those selected recommendations are presented back to the experts in order to get >X % consensus

### General

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

1. A system for automated transmission of communications to a patient following clinical treatment, the system comprising:
one or more electronic datastores storing:
a clinical profile reflective of characteristics of
(i) the patient; and
(ii) clinical treatment undergone by the patient;
a response profile reflective of characteristics of responses by the patient to past communications transmitted by the system; and
a communication modality profile reflective of characteristics of one or more communication channels or devices available for transmission of communications to the patient;
one or more communication interfaces associated with a respective one of the communication channels or devices;
one or more processors in communication with the one or more electronic datastores, the one or more processors configured for:
generating a communication to the patient based on the clinical profile, the communication providing a recommendation or inquiry to the patient;
selecting one of the communication channels or devices based on at least one of (i) the clinical profile and (ii) the response profile; and
transmitting the generated communication to the patient by way of the communication interface associated with the selected communication channel or device.

2. The system of claim 1, wherein the one or more electronic datastores further store a plurality of predefined communications and a plurality of predefined rules governing when the communications should be presented to the patient.

3. The system of claim 2, wherein said generating comprises applying the predefined rules to select from amongst the predefined communications based on the clinical profile.

4. The system of claim 2, wherein the one or more processors are further configured for:
forming a data structure comprising at least part of the plurality of predefined communications and at least part of the plurality of predefined rules; and transmitting the data structure by way of communication interface associated with the selected communication channel or device, for later generation and presentation of communications to the patient.

5. The system of claim 1, further comprising scheduling a time for presenting the communication to the patient.

6. The system of claim 5, wherein said scheduling is based on the clinical profile of the patient.

7. The system of claim 3, wherein the one or more electronic datastores further stores aggregated response characteristics for responses to past communications by a population of patients.

8. The system of claim 7, wherein said scheduling is based on the aggregate response characteristics.

9. The system of claim 5, wherein said transmitting comprises transmitting the generated communication at the scheduled time.

10. The system of claim 5, wherein the transmitting comprises transmitting the generated communication with an indicator of the scheduled time, for later presentation to the patient at the scheduled time.

11. The system of claim 1, wherein the one or more communication interfaces comprises at least one of (i) a WiFi interface, (ii) a mobile telephony interface (iii) a cellular network interface, (iv) a short message system interface, (v) an electronic mail interface, (vi) a web application interface and (vii) a mobile notification interface.

12. A computer-implemented method for automated transmission of communications to a patient following clinical treatment, the method comprising:
maintaining in one or more electronic datastores:
a clinical profile reflective of characteristics of
(i) the patient; and
(ii) clinical treatment undergone by the patient;
a response profile reflective of characteristics of responses by the patient to past communications transmitted by the system; and
a communication modality profile reflective of characteristics of one or more communication channels or devices available for transmission of communications to the patient;
at one or more processors one or more processors in communication with the one or more electronic datastores:
generating a communication to the patient based on the clinical profile, the communication providing a recommendation or inquiry to the patient;
selecting one of the communication channels or devices based on at least one of (i) the clinical profile and (ii) the response profile; and
transmitting the generated communication to the patient by way of a communication interface associated with the selected communication channel or device.

13. The method of claim 12, wherein the one or more electronic datastores further store a plurality of predefined communications and a plurality of predefined rules governing when the communications should be presented to the patient.

14. The method of claim 13, wherein said generating comprises applying the predefined rules to select from amongst the predefined communications based on the clinical profile.

15. The method of claim 13, wherein the one or more processors are further configured for:
forming a data structure comprising at least part of the plurality of predefined communications and at least part of the plurality of predefined rules; and
transmitting the data structure by way of communication interface associated with the selected communication channel or device, for later generation and presentation of communications to the patient.

16. The method of claim 12, further comprising scheduling a time for presenting the communication to the patient.

17. The method of claim 17, wherein said scheduling is based on the clinical profile of the patient.

18. The method of claim 14, wherein the one or more electronic datastores further stores aggregated response characteristics for responses to past communications by a population of patients.

19. The method of claim 7, wherein said scheduling is based on the aggregate response characteristics.

20. The method of claim 5, wherein said transmitting comprises transmitting the generated communication at the scheduled time.

21. The method of claim 5, wherein the transmitting comprises transmitting the generated communication with an indicator of the scheduled time, for later presentation to the patient at the scheduled time.

22. The method of claim 1, wherein the one or more communication interfaces comprises at least one of (i) a WiFi interface, (ii) a mobile telephony interface (iii) a cellular network interface, (iv) a short message system interface, (v) an electronic mail interface, (vi) a web application interface and (vii) a mobile notification interface.
